(19) United States
(12) Patent Application Publication
(10) Pub. No.: US 2018/0299476 A1
(43) Pub. Date: Oct. 18, 2018

(54) LIQUID DISPENSER AND METHOD OF USE

(71) Applicant: Bio-Rad Laboratories, Inc., Hercules, CA (US)

(72) Inventors: Nenad KIRCANSKI, Toronto (CA); Wen-I WU, Ancaster (CA); Amir SADRI, Toronto (CA); Manja KIRCANSKI, Toronto (CA); Neven NIKOLIC, Mississauga (CA); Thanh-Vi TRAN, Scarborough (CA)

(21) Appl. No.: 15/943,366

(22) Filed: Apr. 2, 2018

Related U.S. Application Data
(60) Provisional application No. 62/484,507, filed on Apr. 12, 2017.

(51) Int. Cl. G01N 35/10; G01N 1/18; G01N 1/14

(52) U.S. Cl. CPC G01N 35/1016; G01N 2035/1025; G01N 1/14; G01N 1/18

(57) ABSTRACT

Fraction collector dispensers and methods of using such dispensers are provided. In one embodiment, the dispenser includes an inlet for receiving liquid from a liquid source, wherein the inlet is in fluid communication with an outlet from which liquid is dispensed into a receptacle; and a reservoir in fluid communication with a flow path between the inlet and outlet, wherein the reservoir is configured to receive liquid during movement of the dispenser between receptacles or during movement of receptacles between dispense positions and to receive pressurized air or gas to empty liquid out of the reservoir before or after movement of the dispenser or receptacles, wherein the dispenser is moveable between a first receptacle and a second receptacle or the receptacles are moveable between dispense positions.

### CROSS-REFERENCES TO RELATED APPLICATIONS

This application claims priority to U.S. Provisional Application No. 62/484,507, filed Apr. 12, 2017, which is incorporated by reference herein in its entirety for all purposes.

### BACKGROUND

Fraction collectors are commonly used to collect fractions of liquid from a liquid chromatography system. Fraction collectors collect fractions from a continuous stream of liquid by using a dispenser to dispense the liquid into a receptacle (e.g., a tube, a microwell, a vial, or a bottle). When a sufficient volume of liquid has been collected in the receptacle, either the dispenser is moved to the next receptacle or the next receptacle is moved into a dispense position. During transit of the dispenser or receptacles, liquid can be spilled between receptacles, resulting in loss of precious sample or resulting in contamination of adjacent receptacles and/or of fraction collector surfaces. Diverting liquid to waste during dispenser or receptacle transit can prevent spillage but can result in sample loss. Stopping the flow of liquid during dispenser or receptacle movement can result in backpressure that can damage components of the chromatography system.

### SUMMARY

Disclosed herein are dispensers for dispensing liquid, fraction collectors comprising these dispensers, and methods of using such dispensers.

In an embodiment, a dispenser includes an inlet for receiving liquid from a liquid source, wherein the inlet is in fluid communication with an outlet from which liquid is dispensed into a receptacle; a reservoir in fluid communication with a flow path between the inlet and outlet, wherein the reservoir is configured to receive liquid during movement of the dispenser between receptacles or during movement of receptacles between dispense positions and to receive pressurized air or gas to empty liquid out of the reservoir before or after movement of the dispenser or receptacles, wherein the dispenser is moveable between a first receptacle and a second receptacle or the receptacles are moveable between dispense positions. In some embodiments, the reservoir is proximate to the outlet. In certain embodiments, the reservoir is a disposable pipette tip.

In certain embodiments, the dispenser further comprises a liquid sensor downstream from the reservoir and upstream from the outlet. In some embodiments, the dispenser further comprises two liquid sensors downstream from the reservoir and upstream from the outlet. In some embodiments, the two liquid sensors are separated by a first distance D1 and are located a second distance D2 from a T-junction proximate to the outlet. In certain embodiments, the dispenser further comprises a liquid sensor upstream from the reservoir. In some embodiments, the liquid sensor is an optical sensor comprising a light source directing light across a fluid flow path and an optical detector arranged to receive light.

In some embodiments, the dispenser further comprises a reservoir valve (e.g., a 2-way valve or a pinch valve) downstream from the reservoir, wherein the reservoir valve controls flow of liquid into and out of the reservoir. In some embodiments, the dispenser further comprises a dispense valve (e.g., a 2-way valve, a 3-way valve, or a pinch valve) proximate to the outlet, wherein the dispense valve controls the flow of liquid dispensed by the dispenser. In certain embodiments, the dispenser further comprises a pinch valve proximate the outlet.

In some embodiments, the dispenser further comprises a diverter (e.g., a 3-way valve) upstream of the dispenser. The diverter is configured to divert flow from a flow path to waste. In some embodiments, the dispenser further comprises a passive valve to control flow of liquid to waste.

In certain embodiments, the dispenser further comprises a first air valve (e.g., a 2- or 3-way valve) for controlling access from a pressurized air or gas source to the reservoir. In some embodiments, the dispenser further comprises a second air valve (e.g., a 2- or 3-way valve) for controlling application of pressurized air or gas around the outlet.

In some embodiments, the dispenser further comprises an air flow restrictor upstream from the reservoir.

In an embodiment, a method comprises opening a dispense valve (i.e., allowing fluid flow through the dispense valve) at the outlet of a dispenser to dispense liquid into a first receptacle and closing a 2-way valve downstream from a reservoir, the dispenser comprising an inlet for receiving liquid from a liquid source, wherein the inlet is in fluid communication with an outlet from which liquid is dispensed into a receptacle;

the reservoir in fluid communication with a flow path between the inlet and outlet, wherein the reservoir is configured to receive liquid during movement of the dispenser between receptacles or movement of the receptacles and to receive pressurized air or gas to empty liquid out of the reservoir before or after movement of the dispenser or receptacles; and a liquid sensor downstream from the reservoir, wherein the dispenser is moveable between a first receptacle and a second receptacle or the receptacles are moveable between dispense positions; closing the dispense valve (i.e., stopping fluid flow through the dispense valve), opening the 2-way valve, and opening an air valve upstream from the reservoir before moving the dispenser to the second receptacle or before moving the second receptacle into a dispense position; filling the reservoir with liquid and releasing air from the reservoir while moving the dispenser to the second receptacle or while moving the second receptacle into the dispense position; and opening the dispense valve and pushing the liquid out of the reservoir with pressurized air or gas after moving the dispenser to the second receptacle or after moving the second receptacle into the dispense position, wherein pushing the liquid out of the reservoir with pressurized air or gas is stopped when an absence of liquid is detected by the liquid sensor.

In some embodiments, the method further comprises pushing a hanging drop on the outlet into the second receptacle by flowing pressurized air or gas around the outlet. In certain embodiments, the method further comprises pushing a hanging drop on the outlet into the second receptacle by pinching the flow of liquid through a tube with a pinch valve. In some embodiments in which the liquid sensor comprises a first and second liquid sensor separated by a first distance D1, pushing the liquid out of the reservoir with pressurized air or gas is stopped when air reaches the second liquid sensor. In some embodiments, flow of liquid is stopped when flow of liquid toward an air pressure source is detected by a liquid sensor in the air path upstream from the reservoir.

In some embodiments, a pressure of the pressurized air or gas ranges from 0.1 to 30 pounds per square inch or 0.1 to 10 pounds per square inch.

In certain embodiments, a fraction collector includes any of the dispenser embodiments disclosed herein.

### BRIEF DESCRIPTION OF THE DRAWINGS

FIG. 1 is a schematic of a dispenser for use in a fraction collector according to an embodiment of the invention.

FIG. 2 is a schematic of a dispenser for use in a fraction collector according to a second embodiment.

FIG. 3 is a schematic of a dispenser for use in a fraction collector according to a third embodiment of the invention.

FIG. 4 is a schematic of a dispenser for use in a fraction collector according to a fourth embodiment of the invention.

FIG. 5 is a schematic of a dispenser for use in a fraction collector according to a fifth embodiment of the invention.

FIG. 6 is a schematic of a dispenser for use in a fraction collector according to a sixth embodiment of the invention.

FIG. 7 is a schematic cross sectional side view of a dispenser outlet according to an embodiment of the invention in which air can flow around the outlet to remove a hanging drop.

FIG. 8 is a schematic cross sectional side view of a pinch valve that may be used in a dispenser according to embodiments of the invention. The pinch valve can be used to remove a hanging drop on the outlet.

### DETAILED DESCRIPTION

Described herein are dispensers for use in fraction collectors and methods of using such dispensers. Dispensers and their methods of use have been discovered in which liquid is dispensed without spilling, spurting, or dropping liquid between fraction collector receptacles during dispenser or receptacle travel.

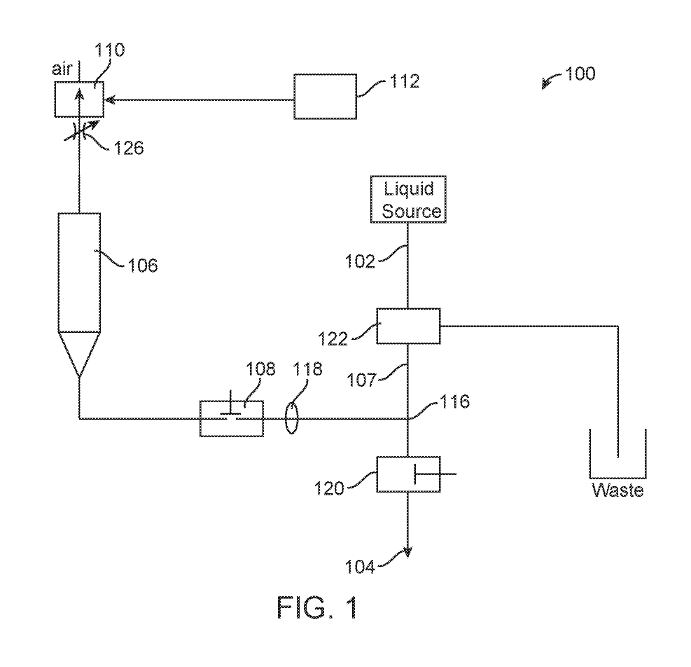

FIGS. 1-6 illustrate embodiments of dispensers 100, 200, 300, 400, 500, and 600, respectively, for dispensing liquid. The dispensers 100, 200, 300, 400, 500, 600 can each be used in a fraction collector configured to collect fractions of liquid from a liquid source (e.g., a liquid chromatography system). For each of the dispensers 100, 200, 300, 400, 500, 600 liquid is received by an inlet 102, 202, 302, 402, 502, 602 in fluid communication with an outlet 104, 204, 304, 404, 504, 604 from which the liquid is dispensed into a receptacle (e.g., a tube, a microwell, a vial, or a bottle). The dispenser is moveable between a first receptacle and a second receptacle or the receptacles are moveable between dispense positions.

The dispenser 100, 200, 300, 400, 500, 600 also includes a reservoir 106, 206, 306, 406, 506, 606 in fluid communication with a flow path 107, 207, 307, 407, 507, 607 between the inlet 102, 202, 302, 402, 502, 602 and outlet 104, 204, 304, 404, 504, 604. The reservoir 106, 206, 306, 406, 506, 606 is configured to receive liquid during movement of the dispenser between receptacles or during movement of receptacles between dispense positions and to receive pressurized air or gas to empty liquid out of the reservoir before or after movement of the dispenser or receptacles. In some embodiments, the reservoir 106, 206, 306, 406, 506, 606 is proximate to the outlet 104, 204, 304, 404, 504, 504.

In some embodiments, the reservoir 106, 206, 306, 406, 506, 606 is a disposable pipette tip having sufficient internal volume to accommodate incoming sample volume while the dispenser or receptacles move. For example, the reservoir 106, 206, 306, 406, 506, 606 can have an internal volume of about 0.1-20 milliliters (e.g., a desired length and internal diameter) to accommodate a flow rate up to and including 200 milliliters/minute and an accumulation time ranging from 0.1-2 seconds.

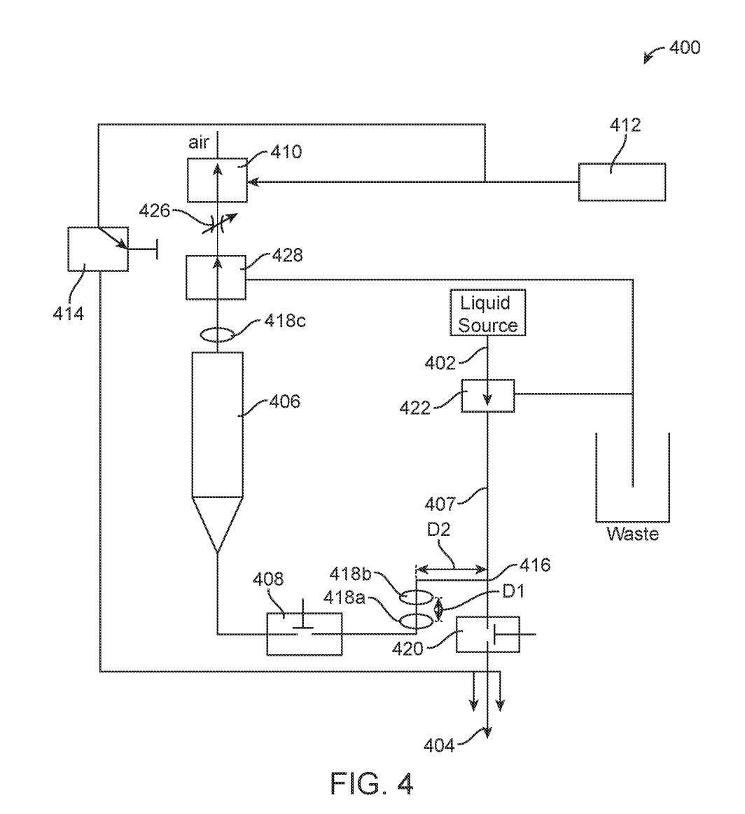

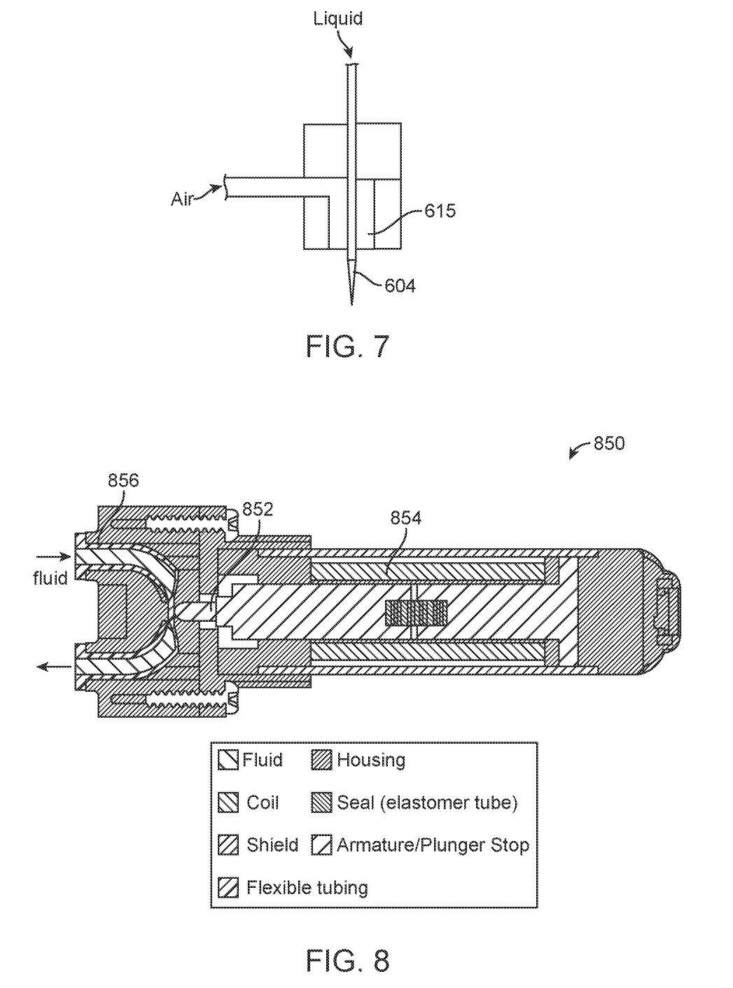

In some embodiments, a first air valve 110, 210, 210, 410, 510, 610 is located upstream from the reservoir 106, 206, 306, 406, 506, 606 in the flow path of the pressurized air or gas. The first air valve 110, 210, 210, 410, 510, 610 controls access from a pressurized air or gas source 112, 212, 312, 412, 512, 612 (e.g., a peristaltic or diaphragm pump) to the reservoir 106, 206, 306, 406, 506, 606. For example, as illustrated in FIGS. 1-6, the first air/gas valve 110, 210, 210, 410, 510, 610 is a 3-way valve that is configured to connect the reservoir 106, 206, 306, 406, 506, 606 to pressurized air/gas or to atmosphere. In some embodiments (FIGS. 4, 5, 6), a second air valve 414, 514, 614 (e.g., a 2-way valve) is located upstream of the reservoir in the flow path of the pressurized air or gas. The second air valve 414, 514, 614 controls the flow of pressurized air or gas from the air/gas source 410, 510, 610 to an area 615 (see FIG. 7) surrounding the outlet and can be used for removing a hanging drop on the outlet.

In certain embodiments, the dispenser 100, 200, 300, 400, 500, 600 comprises a reservoir valve 108, 208, 308, 408, 508, 608 (e.g., a 2-way valve or a pinch valve) downstream from the reservoir 106, 206, 306, 406, 506, 606. The reservoir valve 108, 208, 308, 408, 508, 608 controls flow of liquid into and out of the reservoir 106, 206, 306, 406, 506, 606.

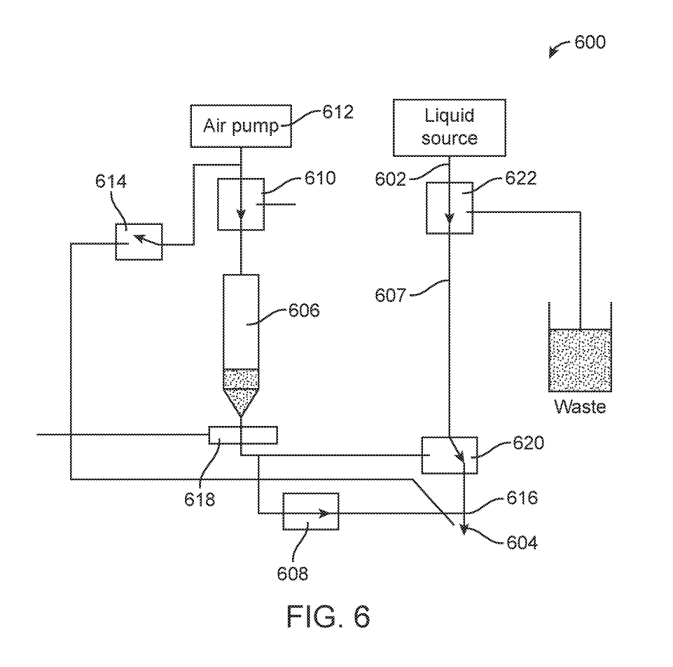

As illustrated in FIGS. 1, 2, 4, 5, and 6, the dispenser 100, 200, 400, 500, 600 can further include a T-junction 116, 216, 416, 516, 616 downstream of the reservoir valve 108, 208, 408, 508, 608. In some embodiments, the T-junction 116, 216, 416, 516, 616 is proximate the outlet 104, 204, 404, 504, 604. In some embodiments, the T-junction is upstream from the dispense valve 120, 220, 420, 520 (FIGS. 1, 2, 4, and 5). In certain embodiments, the T-junction is downstream from the dispense valve 620 (FIG. 6).

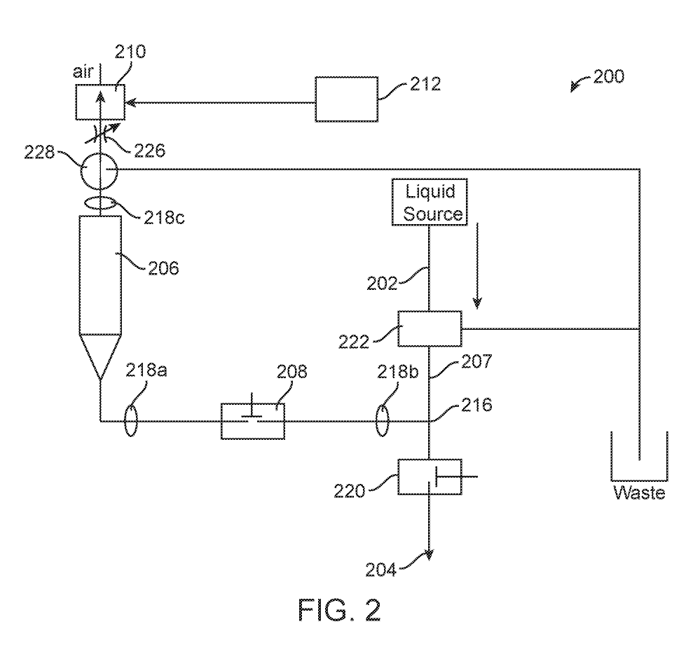

In some embodiments (FIGS. 1, 5, and 6), the dispenser 100, 500, 600 further comprises a liquid sensor 118, 518, 618 downstream from the reservoir 106, 506, 606 and upstream from the outlet 104, 504, 604. The liquid sensor detects air in the flow path when air is used to empty liquid from the reservoir. In some cases (FIGS. 2, 3 and 4), the liquid sensor comprises two liquid sensors 218a/218b, 318a/318b, 418a/418b downstream from the reservoir 206, 306, 406 and upstream from the outlet 204, 304, 404. In some embodiments, the two liquid sensors are separated by a first distance D1 and are located a second distance D2 from the T-junction 416 (FIG. 4). In certain embodiments (FIGS. 2, 3, and 4), the dispenser 200, 300, 400 further comprises a third liquid sensor 218c, 318C, 418c upstream from the reservoir to detect back flow of liquid toward the air pressure source 212, 312, 412. In some embodiments, the liquid sensor is an optical sensor comprising a light source directing light across a fluid flow path and an optical detector arranged to receive light.

In some embodiments, the dispenser 100, 200, 300, 400, 500, 600 further includes a dispense valve 120, 220, 320, 420, 520, 620 proximate to the outlet 104, 204, 304, 404, 504, 604 and configured to control the flow of liquid dispensed by the dispenser 100, 200, 300, 400, 500, 600. In some embodiments, the dispense valve 120, 220, 320, 420 is a pinch valve (FIGS. 1-4). An exemplary pinch valve 850 is illustrated in FIG. 8. The pinch valve 850 comprises a spring loaded plunger 852 that is moveable by a solenoid 854. Normally, a flexible tubing 856 is pinched/closed by the plunger 852. When the solenoid 854 is activated, the plunger 852 releases the flexible tubing 856 so that liquid can flow through the flexible tubing 856.

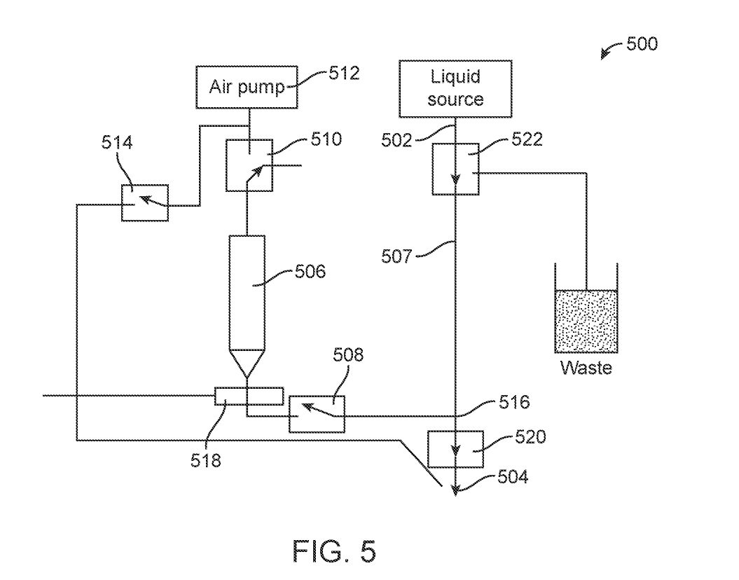

In some embodiments, the dispense valve is a 2-way valve (FIG. 5). In some embodiments, the dispense valve is a 3-way valve (FIG. 6). In embodiments having a dispense valve proximate to the outlet, the dispenser can further include a pressure sensor to monitor backpressure at the liquid source.

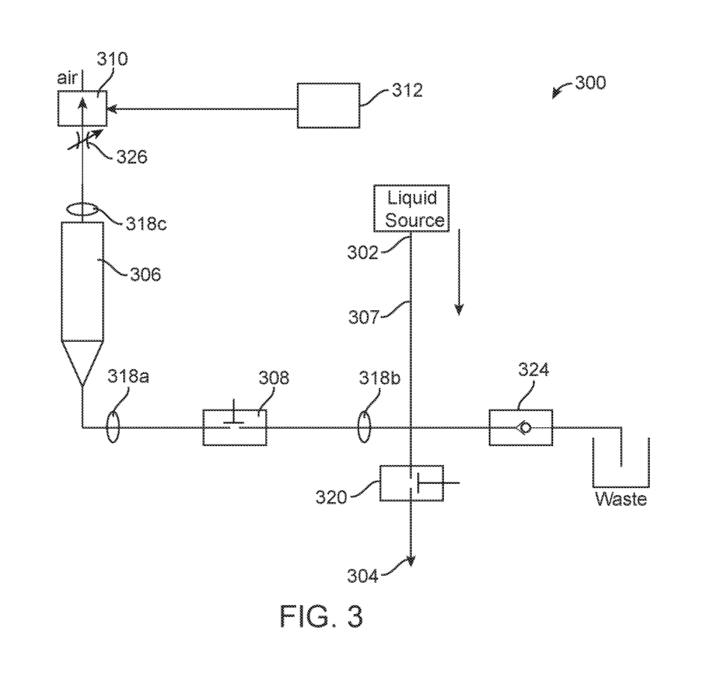

In some embodiments (FIGS. 1-2, 4-6), the dispenser 100, 200, 400, 500, 600 includes a diverter 122, 222, 422, 522, 622 configured to divert liquid flow from the flow path 107, 207, 407, 507, 607 to waste. In certain embodiments, the diverter 122, 222, 422, 522, 622 is located upstream of the dispenser. In some embodiments, the flow diverter is a 3-way valve. In certain embodiments (FIG. 3), a passive valve 324 (e.g., a check valve) controls flow of liquid to waste.

In some embodiments, an air/gas flow restrictor 126, 226, 326, 426 (e.g., a narrow tube, a valve, or a filter) is located in the air/gas flow path (FIGS. 1-4). The air/gas flow restrictor 126, 226, 326, 426 controls the velocity of the pressurized air/gas to the reservoir 106, 206, 306, 406 and prevents spurting of liquid/bubble formation when the reservoir is flushed with pressurized air/gas. With the air/gas flow restrictor 126, 226, 326, 426, the velocity of the air/gas is slow enough to maintain the integrity of the air-fluid interface and the continuity of the slug of liquid as the slug travels in the flow path. In some embodiments, the velocity of the air/gas ranges from 0.1 to 1 meters/second.

In some embodiments, a cleaning valve 228, 428 (e.g., a 3-way valve) is located upstream of the reservoir 206, 406 (FIGS. 2 and 4). The cleaning valve 228, 428 controls flow of cleaning and wash solutions from the reservoir 206, 406 to waste.

In operation of the dispenser 100, 200, 300, 400, 500 the dispense valve 120, 220, 320, 420, 520 located at the outlet 104, 204, 304, 404, 504 is opened (i.e., fluid can flow through the dispense valve) and liquid is dispensed into a first receptacle. The dispense valve 120, 220, 320, 420, 520 is then closed (i.e., fluid cannot flow through the dispense valve) and the reservoir valve 108, 208, 308, 408, 508 is opened before moving the dispenser 100, 200, 300, 400, 500 to a second receptacle or before moving the second receptacle into a dispense position. While moving the dispenser 100, 200, 300, 400, 500 to the second receptacle or while moving the second receptacle into a dispense position, the reservoir 106, 206, 306, 406, 506 in fluid communication with the flow path 107, 207, 307, 407, 507 between the inlet 102, 202, 302, 402, 502 and outlet 104, 204, 304, 404, 504 is filled. After moving the dispenser 100, 200, 300, 400, 500 or the second receptacle, the dispense valve 120, 220, 320, 420, 520 is opened (i.e., fluid can flow through the dispense valve) and liquid is pushed out of the reservoir 106, 206, 306, 406, 506 with pressurized air or gas from the air/gas pump 112, 212, 312, 412, 512. In an embodiment having a first liquid sensor 418a and second liquid sensor 418b separated by a first distance D1 (FIG. 4), pushing the liquid out of the reservoir is stopped when air reaches the second liquid sensor 418b. Stopping the liquid at the second liquid sensor 418b prevents air from entering the flow path 407 and from exiting the outlet 404 which could produce unwanted bubbles.

The first distance D1 between the two liquid sensors and the distance between the second liquid sensor 418b and the T-junction can also be used to determine the speed or velocity at which the liquid should be pushed out of the reservoir 406. The times t1 and t2 at which the liquid reaches the first liquid sensor 418a and the second liquid sensor 418b, respectively, are first measured. The velocity, v, of the liquid is then calculated with the following equation: v=D1/(t2−t1). The time delay (T) between the second liquid sensor 418b and the T-junction can also be calculated with the following equation: T=D2/v, where D2 is the distance between the second liquid sensor 418b and the T-junction.

In certain embodiments (FIGS. 2, 3 and 4), the method further comprises stopping fluid flow into the reservoir during dispenser or receptacle movement if flow of liquid towards an air pressure source 212, 312, 412 is detected with a liquid sensor upstream from the reservoir.

In some embodiments, after the dispenser is moved or the second receptacle is moved into position, a hanging drop is pushed off of the outlet into the second receptacle with pressurized air or gas flowing around the outlet (FIG. 7).

In certain embodiments having a pinch valve proximate the outlet (FIGS. 1-4), the pinch valve can be used in a method for removing a hanging drop on the outlet. In the drop removal method, before or after the dispenser is moved or the receptacles are moved, the pinch valve 850 (FIG. 8) is de-activated (e.g., a solenoid 854 is de-energized) such that the fluid path (e.g., flexible tubing 856) is pinched (e.g., by a plunger 852), which stops fluid flow and ejects a hanging drop on the outlet into a receptacle.

In embodiments using pressurized air or gas to push liquid out of the reservoir or to remove a hanging drop from the outlet, the pressure of the air or gas ranges from about 0.1 to 30 pounds per square inch or from about 0.1 to 10 pounds per square inch. The duration of the air pulse depends on the air pressure, liquid flow rate and the volume of liquid to be flushed out of the flow path. In some embodiments, the duration of the air pulse ranges from about 10 milliseconds to about 5 seconds. In certain embodiments, the duration of the air pulse ranges from about 100 milliseconds to about 1 second.

In embodiments having a cleaning valve 228, 428 (FIGS. 2 and 4), the method can further include cleaning the reservoir by switching the cleaning valve to waste, closing the dispense valve 220, 420, and pumping a cleaning solution (e.g., NaOH) from the liquid source and into the reservoir 206, 406. After a suitable volume of cleaning solution has passed through the reservoir 206, 406, the reservoir can be flushed with a suitable volume of wash solution (e.g., water or buffer).

Dispenser embodiments can be operably connected to a liquid chromatography system (i.e. the liquid source) that includes control circuitry configured to control the operation of the fraction collector and dispenser along with other components of the system.

All patents, patent applications, and other published reference materials cited in this specification are hereby incorporated herein by reference in their entirety. As used in this specification and the appended claims, the singular forms “a”, “an”, and “the” include plural referents unless the content clearly dictates otherwise.

What is claimed is:

1. A dispenser comprising:
an inlet for receiving liquid from a liquid source, wherein the inlet is in fluid communication with an outlet from which liquid is dispensed into a receptacle; and
a reservoir in fluid communication with a flow path between the inlet and outlet, wherein the reservoir is configured to receive liquid during movement of the dispenser between receptacles or during movement of receptacles between dispense positions and to receive pressurized air or gas to empty liquid out of the reservoir before or after movement of the dispenser or receptacles,
wherein the dispenser is moveable between a first receptacle and a second receptacle or the receptacles are moveable between dispense positions.

2. The dispenser of claim 1, further comprising a liquid sensor downstream from the reservoir and upstream from the outlet.

3. The dispenser of claim 1, further comprising two liquid sensors downstream from the reservoir and upstream from the outlet.

4. The dispenser of claim 3, wherein the two liquid sensors are separated by a first distance D1 and are located a second distance D2 from a T-junction proximate to the outlet.

5. The dispenser of claim 1, further comprising a liquid sensor upstream from the reservoir.

6. The dispenser of claim 1, wherein the reservoir is proximate to the outlet.

7. The dispenser of claim 1, further comprising a first air valve for controlling access from a pressurized air or gas source to the reservoir.

8. The dispenser of claim 7, wherein the first air valve is a 3-way valve.

9. The dispenser of claim 7, wherein a pressure of the pressurized air or gas ranges from 0.1 to 30 pounds per square inch.

10. The dispenser of claim 1, further comprising a dispense valve proximate to the outlet, wherein the dispense valve controls the flow of liquid dispensed by the dispenser.

11. The dispenser of claim 10, wherein the dispense valve is selected from the group consisting of a 2-way valve, a 3-way valve, and a pinch valve.

12. The dispenser of claim 1, further comprising a reservoir valve downstream from the reservoir and for controlling flow of liquid into and out of the reservoir.

13. The dispenser of claim 12, wherein the reservoir valve is a 2-way valve or a pinch valve.

14. The dispenser of claim 1, further comprising an air flow restrictor upstream from the reservoir.

15. The dispenser of claim 1, wherein the reservoir is a disposable pipette tip.

16. A fraction collector comprising the dispenser of claim 1.

17. A method comprising:
opening a dispenser valve at the outlet of a dispenser to dispense liquid into a first receptacle and closing a 2-way valve downstream from a reservoir, the dispenser comprising:
an inlet for receiving liquid from a liquid source, wherein the inlet is in fluid communication with an outlet from which liquid is dispensed into a receptacle;
the reservoir in fluid communication with a flow path between the inlet and outlet, wherein the reservoir is configured to receive liquid during movement of the dispenser between receptacles or movement of the receptacles and to receive pressurized air or gas to empty liquid out of the reservoir before or after movement of the dispenser or receptacles; and
a liquid sensor downstream from the reservoir,
wherein the dispenser is moveable between a first receptacle and a second receptacle or the receptacles are moveable between dispense positions;
closing the dispenser valve, opening the 2-way valve, and opening an air valve upstream from the reservoir before moving the dispenser to the second receptacle or before moving the second receptacle into a dispense position;
filling the reservoir with liquid and releasing air from the reservoir while moving the dispenser to the second receptacle or while moving the second receptacle into the dispense position; and
opening the dispenser valve and pushing the liquid out of the reservoir with pressurized air or gas after moving the dispenser to the second receptacle or after moving the second receptacle into the dispense position, wherein pushing the liquid out of the reservoir with pressurized air or gas is stopped when an absence of liquid is detected by the liquid sensor.

18. The method of claim 17, further comprising pushing a hanging drop on the outlet into the second receptacle by flowing pressurized air or gas around the outlet.

19. The method of claim 17, further comprising pushing a hanging drop on the outlet into the second receptacle by pinching the flow of liquid through a tube with a pinch valve.

20. The method of claim 17, further comprising stopping fluid flow when flow of liquid towards an air pressure source is detected with a liquid sensor in the air path upstream from the reservoir.
